(19) United States
(12) Patent Application Publication
(10) Pub. No.: US 2014/0111007 A1
(43) Pub. Date: Apr. 24, 2014

(54) FLEXIBLE THIN FILM SOLAR SHUTTER

(71) Applicant: Institute of Nuclear Energy Research Atomic Energy Council, Executive Yuan, Taoyuan County (TW)

(72) Inventors: TIAN- YOU LIAO, TAOYUAN COUNTY (TW); MIN-CHUAN WANG, TAOYUAN COUNTY (TW); DER-JUN JAN, TAOYUAN COUNTY (TW)

(73) Assignee: Institute of Nuclear Energy Research Atomic Energy Council, Executive Yuan, Taoyuan County (TW)

(21) Appl. No.: 13/903,370

(22) Filed: May 28, 2013

(30) Foreign Application Priority Data
Oct. 19, 2012 (TW) 101138647

(51) Int. Cl. H02J 7/35; H02J 7/02

(52) U.S. Cl. CPC H02J 7/355; H02J 7/025
USPC 307/23

(57) ABSTRACT

A practical product combining a thin film solar cell component with a residential environment is provided. Being flexible and easy to manufacture on a plane material, a silicon thin film solar cell is combined with a shutter used in residential buildings, thereby extending shutter functions. This module integrates energy saving, power generation and elegant appearance by bringing in a flexible and colored solar cell module that is light and thin and can generate power indoors and outdoors. As buildings are becoming higher nowadays, the area exposed to sunlight increases. Solar shutters have great power generation efficiency potential if used a building. The solar shutters can save energy and reduce CO₂ emission when combined with electric products and provide electricity in emergency when combined with a storage device. The thin film solar cell provides components of many colors for customers, thereby providing options for the appearance of the building.

### BACKGROUND OF THE INVENTION

1. Field of Invention

The present invention relates to a shutter module, and more particularly to a flexible thin film solar shutter module.

2. Related Art

With a growing population on the earth and gradual advancement of industry and technology, energy resources required by human beings also increase. However, in recent years, there are international disputes on important primary energy resources such as oil, natural gas, coal and wood, storage of natural resources is limited, and exploiting natural resources brings irreversible destruction to the environment and ecology. Especially, the impact on climate is beyond imagination: disasters, such as greenhouse gases, climatic change, flood, drought and typhoon, due to the rise of temperature are seen everywhere in the word. As long as the population grows continuously on the earth, major natural resources currently used by human beings are deemed to be exhausted one day. In the future, the competition and disputes for the energy resources among human beings will become more intense.

In order to avoid the foregoing scenarios in the future, programs and researches on various alternative energy resources are carried out vigorously. Some are dedicated to new natural resources, such as wind power, hydraulic power, geotherm and solar energy, and some are dedicated to the development of different primary energy resources, such as biomass energy. For energy development, most recent researches focus on discussion and study of solar energy, because solar energy is a natural resource most visible on the earth and the closest to us, and having least pollution and energy loss during photovoltaic conversion. It can be considered as the most feasible clean energy resource in the new generation of resources.

Currently, different kinds of silicon are prevailing materials of solar cells. Silicon is doped with III-V elements and then is used in energy conversion of light. A thin film solar cell has the following advantages: it is easy to manufacture by a large area, a manufacturing procedure is continuous, and an absorption coefficient for visible light thereof is greater as compared with other kinds of solar cells, thereby facilitating application in daily life.

### SUMMARY OF THE INVENTION

The present invention provides a light, thin and flexible energy-saving element, which is a future trend. Through the development of high value-added energy-saving goods and a technology for integrating related products, and through seeking for an integration with daily goods, practical experience can be provided and more energy-saving ideas are encouraged, so that the energy-saving technology is effectively incorporated into daily life.

In the prior art, a chip solar cell applied in outdoor power generation requires high-quality packaging, which inevitably leads to a high packaging cost. The frangibility property of the chip solar cell requires protection, so hard boards and glass are still dominant materials in packaging. In addition, the chip solar cells are mainly placed in a large open area, which limits the range of combining with family life, and an urban land cost is also considerable extra expenditure. If a device is installed in suburbs, a transmission grid needs to be constructed additionally, and subsequent maintenance also requires more manpower. If the thin film solar cell of the present invention is used to generate power outdoors, the foregoing disadvantages can be avoided. Besides, an absorption coefficient on visible light of the thin film solar cell is greater as compared with other types of solar cells, which facilitates application in daily life and indoor applications.

In order to achieve objectives of energy conservation in buildings and effective utilisation of land, currently, in most buildings, the building structure is combined with light-weight glass curtain appearance. In the past, the technology for integrating the thin film solar cell and the building is to form components and the glass as a whole which is then sent to a construction site for installation. However, in this integration manner, the expense for integrating the glass and the solar components increases the construction cost; besides, glass is a fragile material, so any minor deficiency during construction will break the glass, and as a result, the component is scrapped. Therefore, future replacement of the solar cell has a higher technical requirement, and is more expensive and dangerous than replacement of a solar shutter.

The technology of the present invention has the following characteristics:

1. Photovoltaic power generation of a flexible silicon thin film solar cell is combined with a current shutter.

2. The combination of the flexible silicon thin film solar cell and the shutter is cheaper and safer as compared with a conventional product combined with the glass curtain.

3. An area of the product exposed to sunlight can be adjusted according to requirements of a user, and the electric requirement is completely customized.

4. A plurality of appearance colors is provided, and the color can be changed according to the requirements of the user during fabrication.

5. A flexible thin film solar shutter module formed of the flexible silicon thin film solar cell can generate power both indoors and outdoors.

In an embodiment, the present invention provides a flexible thin film solar shutter module, including a plurality of solar cells, the plurality of solar cells forming a plurality of shutter structures of the flexible thin film solar shutter module; a charge-discharge controller, connected to the plurality of solar cells and receiving a corresponding electric current generated in induction of the plurality of solar cells by a light source; a mains power supply, connected to the charge-discharge controller, and a power supply volume of the mains power supply being controlled through the charge-discharge controller; a storage battery, connected to the charge-discharge controller and providing electricity charged by a distribution electric power through the charge-discharge controller, where the distribution electric power is one selected from the mains power supply and the plurality of solar cells, and the storage battery is connected to the flexible thin film solar shutter module, so as to provide a power source for the flexible thin film solar shutter module and to control opening and closing of the plurality of shutters; and a load device, connected to the storage battery and receiving electric power provided by the storage battery.

The plurality of solar cells has a flexible structure; the plurality of shutter structures is formed only by the plurality of solar cells; the plurality of shutter structures is also formed of the plurality of solar cells adhered to a plurality of non-solar cell shutters.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a flexible thin film solar shutter module;

FIG. 2 is a schematic view of a solar shutter structure;

FIG. 3 is a schematic structural view of a solar shutter structure combined with a trademark;

FIG. 4 is a schematic structural view of a solar cell of a flexible solar shutter;

FIG. 5 is a schematic view of a flexible solar shutter;

FIG. 6 is a structural schematic view of a solar cell of a flexible solar shutter adhered to a non-solar cell shutter; and

FIG. 7 is a schematic view of a plurality of shutter structures having adhered non-solar cell shutters.

### DETAILED DESCRIPTION OF THE INVENTION

The present invention is a novel product of a combination between a silicon thin film solar cell 32 and a conventional shutter, in which advantages of the silicon thin film solar cell 32, for example, the thin film solar cell is flexible and light-weight, occupies little space, can be used for combination according to requirements, has lower cost than a conventional silicon wafer solar cell, is easy to plated on different materials and to produce by a large area, are used. The present invention mainly aims to finding out a photovoltaic power generating manner that utilizes space to achieve energy conservation and CO₂ emission reduction in daily life. The main characteristics of the product are as follows:

1. The flexible silicon thin film solar cell 32 has a flexible characteristic, and can be adhered to shutters of any size and of different styles, and consumption of materials and resources needed in manufacturing are less than a conventional glass curtain, contributing to an excellent energy saving and CO₂ emission reduction effect.

2. With characteristics of light weight, small size and photovoltaic power generation of the silicon thin film solar cell 32, and with high flexibility of the silicon thin film solar cell when being adhered to shutters of the building, it is simpler and safer in assembling, disassembling and moving as compared with the glass curtain. Therefore, the thin film solar cell can be installed quickly and simply as long as a finished product is bought, and promotion in the mass consumer market is easy.

3. The shutter is easy to disassemble and assemble, and it is easy to adjust the length and area thereof, so the shutter can be integrated with the silicon thin film solar cell 32, to achieve module customization. The voltage and the electric current can be set according to actual requirements of buyers.

4. To save construction cost, a light transmitting glass curtain made of a light-weight material is usually used on an outer wall of the building, and therefore the style is monotonous. However, the thin film solar cell 32 can provide components of more colors according to requirements of customers, and the appearance of the overall component can have a plurality of colors through slightly changing the thickness of the thin film solar cell 32 or a transparent conductive layer 35, thereby providing an option for the appearance of the building.

5. The solar cell 32 uses photovoltaic power generation, so power can be generated as long as a light source is available at an installation place of the flexible thin film solar shutter module 13. In the daytime, the power can be generated effectively by making the flexible thin film solar shutter module 13 be oriented toward a place exposed to extensive light on the outer wall of the building, and at night, the flexible thin film solar shutter module 13 uses an indoor light source to generate power, thereby reducing power consumption.

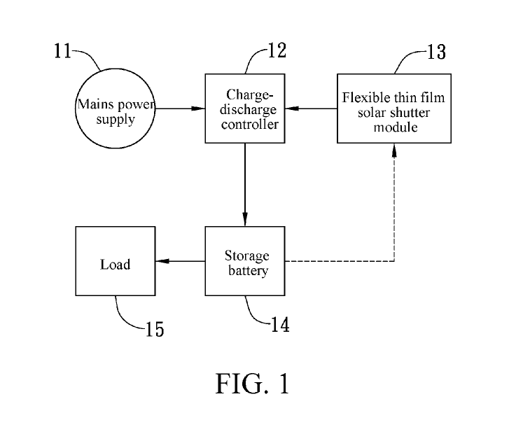

An embodiment of the present invention is a flexible thin film solar shutter module 13. As shown in FIG. 1, the flexible thin film solar shutter module 13 includes: a plurality of solar cells 32, a charge-discharge controller 12, a mains power supply 11, a storage battery 14 and a load device 15.

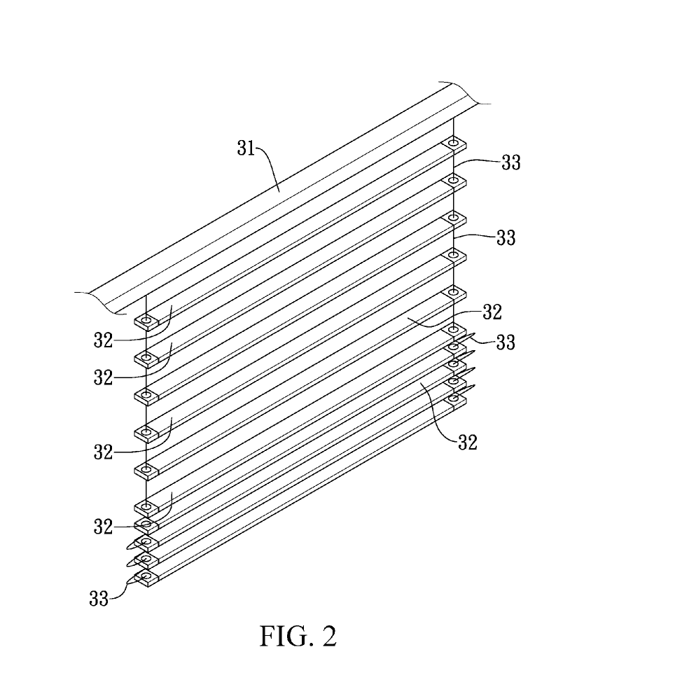

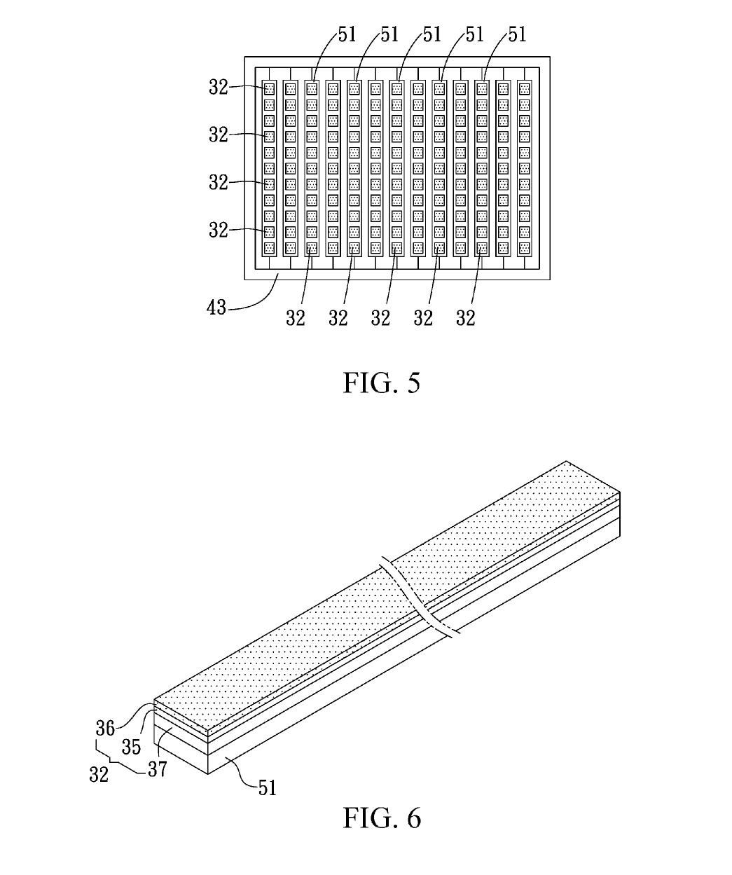

The plurality of solar cells 32 forms a plurality of shutter structures of the flexible thin film solar shutter module 13. The charge-discharge controller 12 is connected to the plurality of solar cells 32 and receives a corresponding electric current generated in induction of the plurality of solar cells 32 by a light source. The mains power supply 11 is connected to the charge-discharge controller 12, and a power supply volume of the mains supply 11 is controlled through the charge-discharge controller 12. The storage battery 14 is connected to the charge-discharge controller 12 and provides electricity charged by distribution electric power through the charge-discharge controller 12, where the distribution electric power is one selected from the mains power supply 11 and the plurality of solar cells 32, and the storage battery 14 is connected to the flexible thin film solar shutter module, so as to provide a power source for the flexible thin film solar shutter module and to control opening and closing of the plurality of shutters. The load device 15 is connected to the storage battery 14 and receives electric power provided by the storage battery 14. The plurality of solar cells 32 has a flexible structure. The plurality of shutter structures is only formed of the plurality of solar cells 32, is connected to the plurality of solar cells 32 via a wire 33, and is supported by a shutter bracket 31 as shown in FIG. 2. The plurality of shutter structures is also formed of the plurality of solar cells 32 adhered to a plurality of non-cell shutters 51, as shown in FIG. 5.

As shown in FIG. 4, the plurality of solar cells 32 includes: a flexible substrate 37, a transparent conductive layer 35, and a thin film layer 36. The flexible substrate 37 is jointed on a bottom layer of the plurality of solar cells 32; the transparent conductive layer 35 is jointed above the flexible substrate 37; and the thin film layer 36 is jointed above the transparent conductive layer 35. The film layer 36 is formed of a plurality of silicon film layers 36 and provides a light absorption function of solar energy.

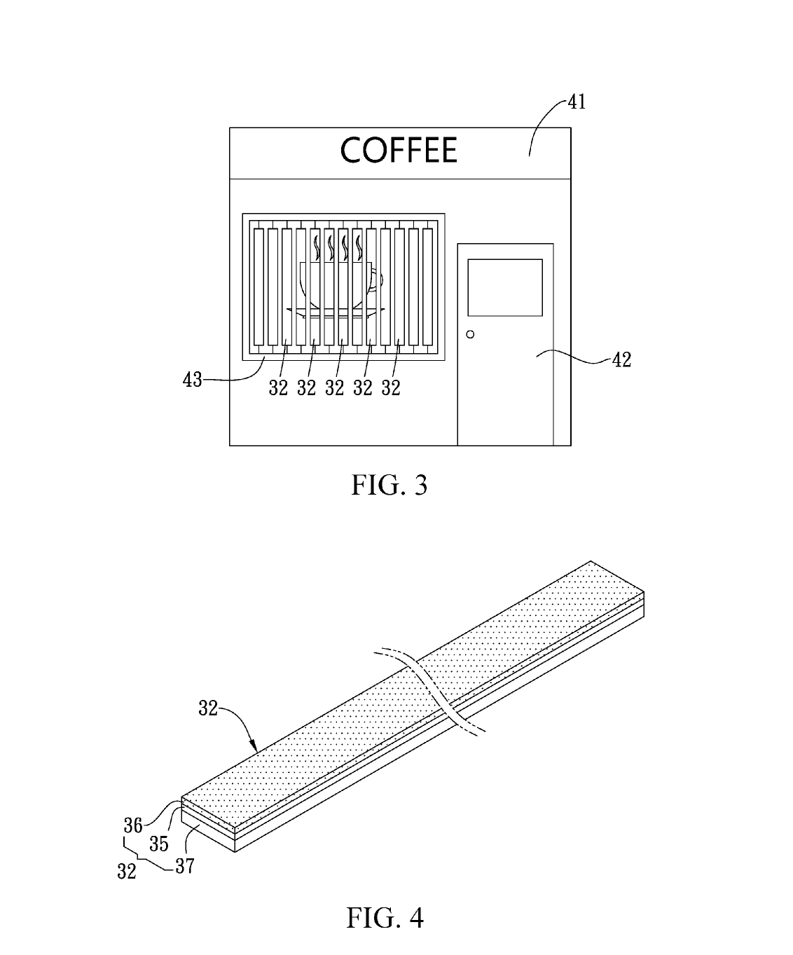

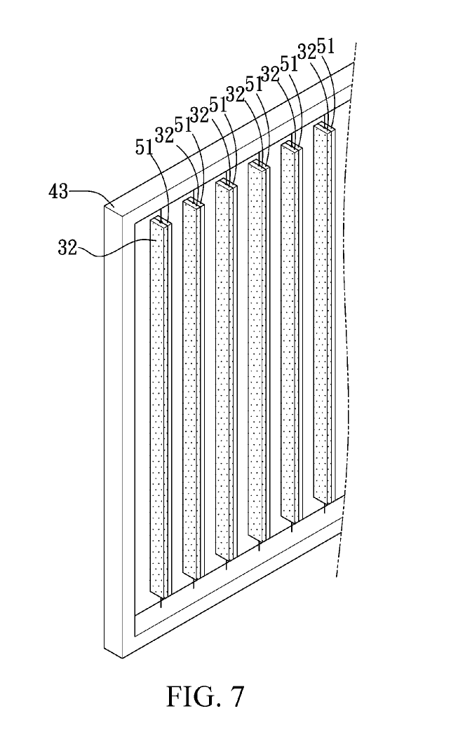

The adjustment of thickness of each layer in the plurality of solar cells 32 may form different color combinations of the plurality of solar cells 32. Under sunlight, the solar shutter is adjusted to be oriented toward the sun, so as to absorb energy from the sun. Without sunlight, the solar shutter is adjusted to be oriented toward an indoor light source, so as to absorb energy from the indoor light source. As shown in FIG. 3, the forming the different color combinations of the plurality of solar cells 32 includes forming a trademark pattern among the plurality of solar shutters, in which a door 42, a window 43 and a plurality of solar cells 32 of different colors are located under the a coffee advertising board 41, forming a trademark pattern, such as a coffee cup in FIG. 3, which is formed by the plurality of solar shutters. The load device is a computer device, a communication device, a household appliance device, a light source device or an electric actuator. Materials of the flexible substrate 37 are steel, resin and plastics. As shown in FIG. 6, the plurality of shutters also includes: a solar cell 32, which has a strip-shaped structure; and a non-solar cell shutter 51, having the same strip shape as the solar cell, and being adhered to the solar cell 32. A material of the non-solar cell shutter 51 may be one selected from cloth, Styrofoam, and plastics, so that the solar cells 31 of the plurality of shutters have a solar light absorption function, and the non-solar cell shutter 51 has a good appearance, as shown in FIG. 7.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A flexible thin film solar shutter module, comprising:
a plurality of solar cells, the plurality of solar cells forming a plurality of shutter structures of the flexible thin film solar shutter module;
a charge-discharge controller, connected to the plurality of solar cells, and receiving a corresponding electric current generated when the plurality of solar cells inducts a light source;
a mains power supply, connected to the charge-discharge controller, and a power supply volume of the mains power supply being controlled through the charge-discharge controller;
a storage battery, connected to the charge-discharge controller, and providing electricity charged by distribution electric power through the charge-discharge controller, wherein the distribution electric power is selected from one of the mains power supply and the plurality of solar cells, and the storage battery is connected to the flexible thin film solar shutter module, so as to provide a power source for the flexible thin film solar shutter module and to control opening and closing of the plurality of shutters; and
a load device, connected to the storage battery, and receiving electric power provided by the storage battery,
wherein the plurality of solar cells has a flexible structure;
the plurality of shutter structures is formed of the plurality of solar cells; and
the plurality of shutter structures is also formed of the plurality of solar cells adhered to a plurality of non-solar cell shutters.

2. The flexible thin film solar shutter module according to claim 1, wherein the plurality of solar cells comprises:
a flexible substrate, jointed on a bottom layer of the plurality of solar cells;
a transparent conductive layer, jointed above the flexible substrate; and
a thin film layer, jointed above the transparent conductive layer, the film layer being formed of a plurality of silicon thin film layers, and providing a light absorption function of solar energy.

3. The flexible thin film solar shutter module according to claim 2, wherein adjustment of thickness of each layer in the plurality of solar cells forms different color combinations of the plurality of solar cells.

4. The flexible thin film solar shutter module according to claim 3, wherein, when exposed in sunlight, the solar shutter is adjusted to be oriented toward the sun, so as to absorb energy from the sun.

5. The flexible thin film solar shutter module according to claim 4, wherein, without sunlight, the solar shutter is adjusted to be oriented toward an indoor light source, so as to absorb energy from the indoor light source.

6. The flexible thin film solar shutter module according to claim 5, wherein the forming the different color combinations of the plurality of solar cells also comprises forming a plurality of solar shutters formed by a trademark pattern.

7. The flexible thin film solar shutter module according to claim 6, wherein materials of the flexible substrate are steel, resin and plastics.

8. The flexible thin film solar shutter module according to claim 7, wherein the load device is a computer device, a communication device, a household appliance device, a light source device or an electric actuator.

9. The flexible thin film solar shutter module according to claim 8, wherein the plurality of shutters also comprises:
a solar cell, having a strip-shaped structure; and
a non-solar cell shutter, having the same strip shape as that of the solar cell, and being adhered to the solar cell,
wherein a material of the non-solar cell shutter is one selected from cloth, Styrofoam, and plastics, so that the solar cells of the plurality of shutters have a solar light absorption function and the non-solar cell shutter has a good appearance.
